(19) United States
(12) Patent Application Publication
(10) Pub. No.: US 2025/0375928 A1
(43) Pub. Date: Dec. 11, 2025

(54) MULTI-SHOT INJECTION MOLDING FOR SELECTIVELY METALIZING PARTS

(71) Applicant: LACKS ENTERPRISES, INC., Grand Rapids, MI (US)

(72) Inventors: Thomas HAWKINS, Grand Rapids, MI (US); James PEPLINSKI, Grand Rapids, MI (US)

(73) Assignee: LACKS ENTERPRISES, INC., Grand Rapids, MI (US)

(21) Appl. No.: 19/229,488

(22) Filed: Jun. 5, 2025

Related U.S. Application Data
(60) Provisional application No. 63/656,288, filed on Jun. 5, 2024.

(51) Int. Cl. B29C 45/16; B29C 45/00; B29K 25/00; B29K 105/00; B29L 31/30

(52) U.S. Cl. CPC B29C 45/16; B29C 45/0001; B29C 2045/0079; B29K 2025/08; B29K 2105/0085; B29K 2995/0021; B29L 2031/3005

(57) ABSTRACT

A polymeric component for a vehicle includes a first member formed of a first polymer resin, and a second member formed of a non-plateable resin and combined with the first member. The second exposed surface of the second member has a non-metallic finish. The non-plateable resin of the second member is an acrylate resin such as SMMA (Styrene Methyl Methacrylate copolymer). The SMMA resin is modified to add an impact modifier including SBC (Styrene Butadiene co-polymer). The non-metallic resin of the second member is molded onto the first polymer resin of the first member by a two-shot injection molding process or an overmolding process. The first polymer resin is plateable such as ABS, PC/ABS, or ABS/PC, or non-plateable such as PC, ASA, or ASA/PC.

### CROSS-REFERENCE TO RELATED APPLICATIONS

This application claims priority to and the benefit of U.S. Provisional Patent Application No. 63/656,288, filed Jun. 5, 2024, the content of which is incorporated herein by reference in its entirety.

### FIELD

The present disclosure relates to methods for metalizing parts. More particularly, the present disclosure relates to methods of multi-shot injection molding and metal plating articles made therefrom.

### BACKGROUND

The statements in this section merely provide background information related to the present disclosure and may not constitute prior art.

The automotive industry is increasingly interested in incorporating metalized plastic parts with multiple finishes into vehicles. Utilizing multiple finishes on a single part has the advantage of potentially being less expensive than assembling multiple parts as well as having a consistent, well defined interface between finished areas. Additionally, assembling multiple parts can lead to gaps and noise from “rattle” or vibrations. These defects will not be present if a multi-part assembly can be consolidated into a single part.

A common method of selectively plating a molding is to form a part using a 2-shot molding or overmolding of a plateable resin such as ABS or PC/ABS and a non-plateable resin such as polycarbonate (PC). The molding is then processed through the plating facility where the plateable areas of the molding receive a metallized finish while the non-plateable areas do not receive plating. It is essential that the non-plateable resin be inert to the plating process such that it does not discolor, lose gloss, or absorb catalyst in the plating process such that it develops metallization in undesired areas. Polycarbonate is typically the material of choice for non-plateable resin in these instances because it creates a solid bond with the ABS resin used in the part, it does not discolor or lose gloss, and in instances where transparency is required it minimizes haze and remains transparent. However, polycarbonate suffers from having very poor scratch and mar resistance, and it is not weatherable. To overcome these limitations, it is necessary to add a protective coating to the PC which will improve the scratch resistance and offer increased resistance to yellowing and crazing due to exposure to UV radiation.

Various examples in the patent literature have also claimed acrylates such as PMMA (Polymethyl Methacrylate) as an alternative non-plateable resin (see U.S. Pat. No. 9,062,386B2 as an example). PMMA can be used in this way however it is most successfully incorporated as a colored opaque material because it is not inert to the plating process. As a tinted translucent resin, or transparent resin, it will lose some degree of light transmission and develop haze after the plating process is complete due to the harsh oxidizing conditions present in the etch bath. It is a desirable alternative to PC because it offers greater resistance to scratch and mar and it is resistant to yellowing upon exposure to UV light without the use of UV absorbing additives or coatings.

### SUMMARY

In the present disclosure, it is disclosed that an acrylate resin known as SMMA (Styrene Methyl Methacrylate copolymer) can be used as a non-plateable resin. This class of resins may have SBC (Styrene Butadiene Copolymer) added as a rubberized section to increase impact resistance. It has been well documented for decades that butadiene is very susceptible to oxidation in the etch bath of a standard plating line. In fact, the butadiene phases in ABS (Acrylonitrile Butadiene Styrene) are the first groups to get digested in this stage of the electroplating on plastics process producing the “holes” containing the now hydrophilic areas that trap catalyst. The morphology of the etched plastic is roughened to the point where, after the surface voids are filled with metal, a mechanical bond is present between the electroplated layers and the resin.

According to an exemplary form of the present disclosure, a polymeric component for a vehicle includes a first member formed of a first polymer resin, and a second member formed of a non-plateable resin and molded with the first member. The first member includes a first exposed surface and the second member includes a second exposed surface. The non-plateable resin of the second member is an acrylate resin such as SMMA (Styrene Methyl Methacrylate copolymer). In the present disclosure, further, the SMMA resin is modified to add an impact modifier. For example, when the SMMA resin with SBC (Styrene Butadience Copolymer) added as one of the impact modifiers (i.e., the SMMA+SBC resin) is placed in the etch bath for an etching process, the resin appears to be inert to the process despite the presence of polymerized Butadience in the resin. Further, the second exposed surface of the second member has a non-metallic finish.

According to a further aspect of the present disclosure, the first polymer resin is plateable such as ABS, PC/ABS, or ABS/PC such that the first exposed surface is plated with a metallic finish. For example, the first polymer resin is formed as a Mold-in-Color (MIC), referring to color and finish that are completed in the molding step. The color and finish are present on the finished resin with a color such that the first polymer resin is formed with a color. In the polymeric component, further, since the SMMA resin with an impact modifier over-molded onto the portion of the first polymer resin (e.g., formed as a Mold-in-Color (MIC)) is transparent, the portion having a color of the MIC resin may be visible through the SMMA resin with an impact modifier, and this transparently covered portion may be defined as a colored region. After a plating process, accordingly, the polymeric component includes a 3-tone appearance including an exposed metallized region (i.e., an exposed MIC resin), a covered and visibly colored region, and a non-metallized region (i.e., a SMMA resin with an impact modifier).

According to a further aspect of the present disclosure, the first polymer resin is non-plateable such as PC, ASA, or ASA/PC such that the first exposed surface has a non-metallic finish. As described above, the non-plateable polymer is also formed as a MIC with a color. In the polymeric component, for example, a portion of the MIC resin which is not covered by the SMMA resin with an impact modifier may be defined as an exposed non-metallized region and the other portion of the MIC resin covered by the SMMA resin with an impact modifier may be visible through the SMMA resin with an impact modifier, and this transparently covered portion may be defined as a colored region. Accordingly, the polymeric component includes a 3-tone appearance having an exposed non-metallized region, a covered and visibly colored region, and a non-metallic SMMA region including an impact modifier. The non-metallized region of the polymeric component may be tinted and/or diffused. Further, the SMMA resin may be modified to add an impact modifier such as SBC and also may be processed clear, tinted, clear diffused, or tinted and diffused.

According to a further aspect of the present disclosure, as described above, the colored region of the polymeric component includes the first portion of the first member and a second portion of the second member overmolded onto the first portion of the first member such that a color of the first member is visible through the second portion of the second member. Further, the colored region of the polymeric component further includes a texture.

According to a further aspect of the present disclosure, the colored region and the non-metallized region of the polymeric component define the second exposed surface formed with the non-metallic finish. The non-metallized region of the polymeric component further includes a backlight such that a light of the backlight passes through the non-metallized region.

According to another aspect of the present disclosure, a method for forming a polymeric component for a vehicle includes the steps of providing a first member formed of a first polymer resin, combining a second member formed of a non-plateable resin with the first member. The polymeric component includes a first exposed surface formed on the first member and a second exposed surface formed on the second member, and the second exposed surface has a non-metallic finish.

According to a further aspect of the present disclosure, the step of combining the second member with the first member includes the step of molding the second member (e.g., a non-plateable material) onto the first member (e.g., a plateable material) by a two-shot injection molding process or an overmolding process.

According to a further aspect of the present disclosure, the step of combining the second member with the first member includes the step of molding the first member (e.g., a plateable material) onto the second member (e.g., a non-plateable material) by a two-shot injection molding process or an overmolding process.

For example, the plateable material may be molded with the non-plateable material by the two-shot injection molding process or the overmolding process (i.e., the plateable material is first molded, and then the non-plateable material gets molded onto the plateable material). In another approach, the non-plateable material may be molded with the plateable material by the two-shot injection molding process or the overmolding process (i.e., the non-plateable material is first molded, and then the plateable material gets molded onto the non-plateable material).

As described above, the first member may be formed of either a plateable resin or a non-plateable resin. Accordingly, when the first member is also a non-plateable resin, it will be appreciated that the order of overmolding process of the two materials (first member and second member) or the two-shot process with the two materials (first member and second member) can also be performed in either order.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a top view of a polymeric component having 3-tone appearance in accordance with an exemplary form of the present disclosure, and FIG. 1A is a cross-sectional view of the polymeric component, taken along line A-A of FIG. 1;

FIG. 2 is a top view of a second polymeric component having 3-tone appearance in accordance with a secondary form of the present disclosure, and FIG. 2A is a cross-sectional view of the second polymeric component, taken along line A-A of FIG. 2;

FIG. 3 is an example showing a non-plateable resin such as SMMA after various stages of UV testing;

FIG. 4A is an example showing the SMMA plaque remaining transparent after a plating process, and FIG. 4B is an example showing the PMMA plaque, which is not inert to the etch chemistry; and

FIG. 5A shows an example showing the SMMA plaque after completing the plating process through electroless Cu, and FIG. 5B shows an example showing the PMMA plaque after completing the plating process through electroless Cu.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

The present disclosure pertains to an improved, streamlined process to make improved plastic components having both metalized and non-metalized surface regions. Further, the present disclosure includes the polymeric articles, such as decorative molded polymeric components, comprising a surface having one or more metallized surface regions and one or more non-metallized surface regions. The surface having one or more of such metallized regions includes major surface of the plastic component being covered with a metallic material, and, in certain aspects, the non-metallized surface region may have a colored surface finish (e.g., tinted and/or diffused). The metallized surface regions are formed over a first polymer that is metallizable, such as a metal-plateable polymer, and the non-metallized surface regions are formed and defined by a polymer that is resistant to metallization, in particular resistant to metal deposition during a metallization process. For example, the metallization process may be a metal-plating process such as a direct wet metallization chemistry process. In another approach, different metal-plating processes may be used for the metallization process.

The metal-plating process may have a plating coat including a metallic gloss such as chromium or tinted chromium. The plating coat is formed on the surface of the polymer components. For example, the chrome plating creates a smooth, bright chrome finish. Further, the chrome plating may have tinted lustrous metallic finish, such as black chrome, gold-tinted chrome and other tinted or colored metallic finishes for decorative purposes. To perform the plating coating, several methods such as electroplating process and physical vapor depositing (PVD) process are used to achieve colored metallic finishes. For example, the electroplating process may create black chrome and bronze finishes and the PVD process may create a wider variety of color finishes.

The molded polymeric component may include a surface that has one or more colored surface regions exhibiting a color in the visible wavelength range, which has a degree of contrast in opacity and/or color spectrum as compared to other surface regions (particularly from metallized surface regions). For example, the polymeric component is formed by at least two polymeric materials through either two-shot injection molding or overmolding process. In another approach, the polymeric component may be formed via a multi-shot injection molding process. According to an exemplary form of the present disclosure, the polymeric component may be formed with two polymers such as a first polymer and a second polymer by a two-shot molding process such that the polymeric component is formed as a single part.

In the present disclosure, the first polymer is a first injection-molded metal-plateable resin, which has a first surface having one or more metallized regions and the second polymer is a second injection-molded resin, which is resistant to the metallization. As described above, the second polymer is integrally molded with (i.e., molded onto) the first polymer by the two-shot injection molding process or the overmolding process and one or more interface regions are formed where the first polymer contacts the second polymer. For example, in the present disclosure, the first polymer may be molded with the second polymer such that the second polymer may cover or encapsulate one or more portions of the first polymer having a portion or interface defined between the first polymer and the second polymer (i.e., the first polymer is first molded, and then the second polymer gets molded onto the first polymer). In another approach, the second polymer may be molded with the first polymer such that the first polymer may cover or encapsulate one or more portions of the second polymer (i.e., the second polymer is first molded, and then the first polymer gets molded onto the second polymer).

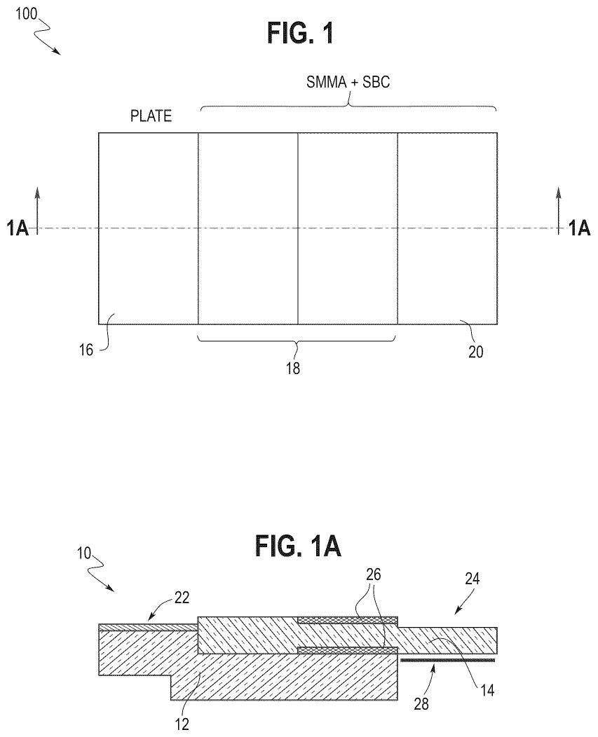

In accordance with an exemplary embodiment of the present disclosure, FIG. 1 shows a top view of a polymeric component 10 having four different regions and FIG. 1A shows a cross-sectional view of the polymeric component 10 of FIG. 1. For example, the polymeric component 10 may be formed with two members such as a first member 12 and a second member 14 by a two-shot injection molding process or an overmolding process as a single unit. In another approach, however, the polymeric component 10 may be formed with more than two members by a multiple-shot injection molding process.

As shown in FIG. 1, the polymeric component 10 includes a first member 12 formed of the first polymer, which is a metal-plateable polymer such as plateable ABS (e.g., Mold in Color, MIC). The Mold in Color (MIC) generally refers to color and finish that are completed in the molding step of the product, which is formed of a resin material. The color and finish coming out of the mold are present on the finished resin with a particular color. Accordingly, the finished resin (i.e., the MIC resin) may be used as is without further paint, plating, etc. The polymeric component 10 further includes a second member 14 formed with the second polymer, which is a non-plateable resin such as an acrylate resin known as SMMA (Styrene Methyl Methacrylate copolymer). In the present disclosure, for example, the SMMA resin may be modified with an impact modifier such as SBC (Styrene Butadience Copolymer), polybutadiene, other impact known modifiers, etc. Accordingly, the SMMA resin with an impact modifier may refer to a styrene acrylate co-polymer, which is listed as SMMA+impact modifier resin. In particular, when the SMMA resin modified to add SBC as an impact modifier (listed as SMMA+SBC resin) is placed in the etch bath, the resin appears to be inert to the process despite the presence of polymerized Butadience in the resin. In general, the impact modifiers such as polybutadiene are used in ABS resin consumed by the chromic acid etch which in turn makes the surface able to retain catalyst for electrochemical deposition and gives the plating adhesion. Unexpectedly, however, the impact modifiers including SBC, polybutadiene, etc. used in the SMMA resin does not react with an etching process in the present disclosure such that the impact modifiers does not etch, haze, or plate. Further, because the SMMA resin, like PC, is transparent, has good impact properties, and is inert to the plating process, it is used as a non-plateable resin in the polymeric component 10 as shown in FIG. 1.

In FIGS. 1 and 1A, for example, the polymeric component 10 includes a 3-tone appearance utilizing plateable hi-gloss ABS (e.g., MIC resin) with an overlayer of non-plateable SMMA resin or SMMA+SBC resin that covers a portion of the glossy ABS. After a plating process, the polymeric component 10 comprises a first region 16 defining a metallized region, a second region 18 defining a MIC region covered by SMMA+SBC resin, and a third region 20 defining non-plateable (non-metallized) region (i.e., SMMA+SBC resin). In the second region 18, the glossy ABS (i.e., MIC resin) is not plated, and is visible through the SMMA+SBC resin overlay. Further, the second region 18 is optionally constructed with texture 26 or without texture. As shown in FIG. 1A, the polymeric component 10 is formed by a two-shot injection molding process. After the plating process, the first member 12 has a metallized surface finish 22, defined the first region 16, and the second member 14 is over-molded on to the first member 12 to cover a portion of the first member 12, defined as the second region 18. Further, the polymeric component 10 includes a non-metallized surface 24, defined as the third region 20.

As described above, for example, the SMMA+SBC resin (or the SMMA+impact modifier resin) formed in the second member 14 may be processed clear, tinted, clear diffused, or tinted and diffused such that the SMMA+SBC resin over-molded on to the portion of the first member 12 (i.e., the MIC resin) may serve to protect the underlying MIC resin from exposure to an external environment. Further, since the SMMA+SBC resin over-molded onto the portion of the MIC resin is transparent, the portion of the MIC resin covered by the SMMA+SBC resin is visible to the external environment, and this transparently covered portion may be defined as a colored region. As shown in FIGS. 1 and 1A, in the colored region, the color of the MIC resin covered by the SMMA+SBC resin may be visible through the SMMA+SBC resin overlayer. Accordingly, in FIG. 1A, the polymeric component 10 has the 3-tone appearance (i.e., a plated region, a colored region w/texture or w/o texture, and a non-plated region with clear, tinted clear, diffused, or diffused & tinted appearance) by the two-shot injection molding or over-molding process. Given the texture 26 that may be provided, the component 10 may also be considered to have a 4-tone appearance. Further, the non-plated region (i.e., the non-metallized region) is capable for having a backlight 28 such that the light passes through the transparent non-plated region. Accordingly, in the present disclosure, the polymeric component 10 formed with two polymer resins as described above allows the following constructions such as i) selective plating over hi-gloss ABS, ii) selective plating with texture, iii) selective plating with texture and backlighting, iv) selective plating with tinted areas, v) selective plating with tinted areas over texture, vi) selective plating with tinted areas over texture and backlighting, or vii) same combinations listed above with diffused/diffused and tinted.

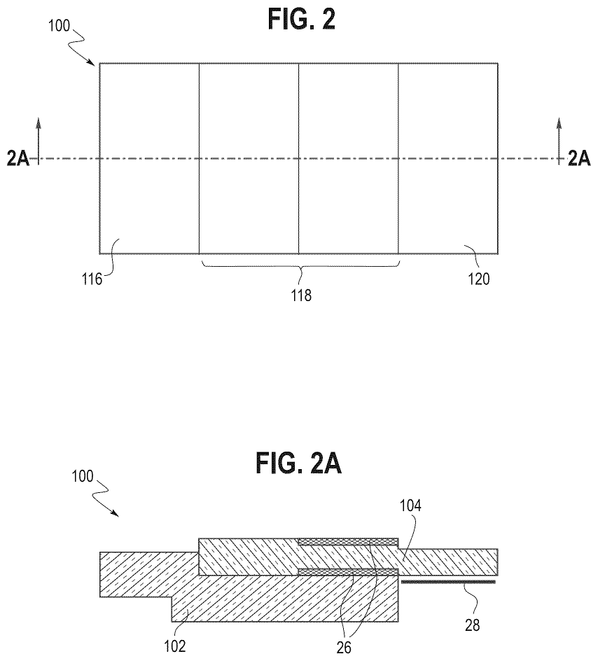

In accordance with a secondary embodiment of the present disclosure, FIG. 2 shows a second polymeric component 100 and also FIG. 2A shows a cross-sectional view of the second polymeric component 100 of FIG. 2. The second polymeric component 100 is similar to the polymeric component 10 of FIG. 1, but includes a first member 102 formed of a first polymer resin such as polycarbonate (PC), Acrylonitrile-styrene-acrylate (ASA), or ASA/PC (i.e., another Mold in Color (MIC) resin) and a second member 104 formed of a second polymer resin such as SMMA with an impact modifier including SBC, which is formed in the second member 14 of the polymeric component 10 of FIG. 1 (i.e., SMMA+impact modifier resin or SMMA+SBC resin). Further, the first member 102 and the second member 104 are combined to each other by a two-shot injection molding process or an overmolding process such that the second polymeric component 100 is formed as a single unit. Unlike the polymeric component 10 of FIG. 1, the second polymeric component 100 of FIG. 2 does not go through the plating process such that the first and second members 102 and 104 of the second polymeric component 100 are not at all metallized.

As shown in FIGS. 2 and 2A, for example, the second polymeric component 100 also includes a 3-tone appearance utilizing the second MIC resin with an overlayer of the SMMA+SBC resin (or the SMMA+impact modifier resin) that covers a portion of the first member 102. Accordingly, the second polymeric component 100 comprises a first region 116 defining a non-metallized region, a second region 118 defining the second MIC resin covered by the SMMA+SBC resin, and a third region 120 also defining the SMMA+SBC resin region. As described above, the second region 118 is optionally constructed with texture or without texture. For example, in FIG. 2A, the second polymeric component 100 is formed by a two-shot injection molding process. In another approach, the second polymeric component 100 may be also formed by an overmolding process.

As shown in FIG. 2A, further, the non-metallized region 116 of the second polymeric component 100 has the non-metallized surfaces finish, which is tinted and/or diffused. The SMMA+SBC resin formed in the second member 104 may be processed clear, tinted, clear diffused, or tinted and diffused such that the SMMA+SBC resin over-molded onto the portion of the first member 102 (i.e., the second MIC resin) may serve to protect the underlying the second MIC resin from exposure to an external environment. Because the SMMA+SBC resin over-molded onto the portion of the second MIC resin is transparent, the portion of the second MIC resin covered by the SMMA+SBC resin may be visible to the external environment such that the color of the second MIC resin is visible through the transparent SMMA+SBC resin overlayer (i.e., defined as a colored region).

Accordingly, as shown in FIG. 2A, the second polymeric component 100 has the 3-tone appearance such as the non-metallic surface finish (tinted and diffused) defined in the first region 116, the SMMA+SBC resin over the second MIC resin defined in the second region 118, and the transparent SMMA+SBC resin defined in the third region 120. Further, the transparent SMMA+SBC resin (i.e., third region 120) is capable for having also the backlight 28 such that the light passes through the transparent SMMA+SBC resin region.

The suitable polymers for forming the metal plateable member 12 include acrylonitrile-butadiene-styrene (ABS), polycarbonate (PC), PC/ABS, or ABS/PC with a cohesive bond between resins, and the suitable polymer for forming the metal non-plateable member 14 includes the SMMA resin with SBC or impact modifiers such as, Acrylonitrile-styrene-acrylate (ASA) or PC with a cohesive bond between resins, and/or ASA+PC.

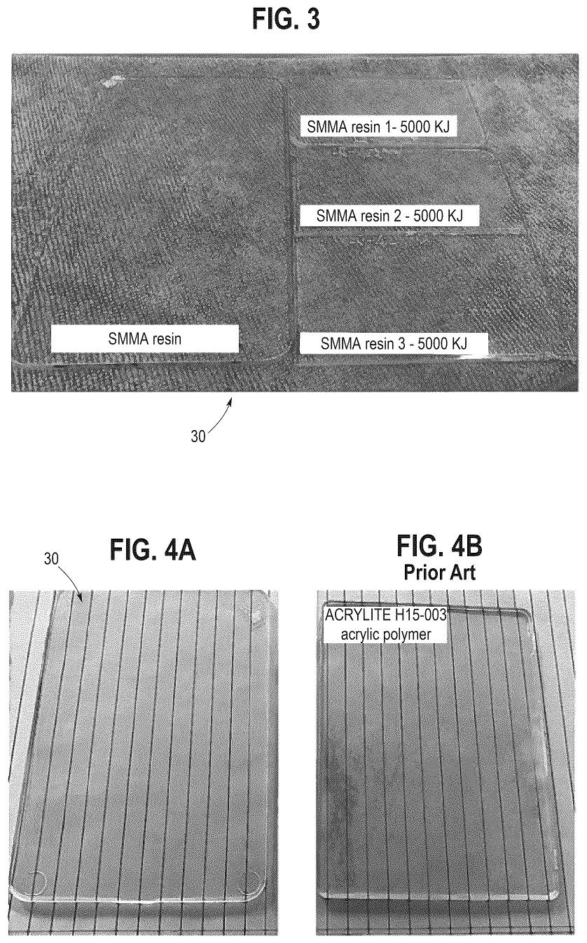

The SMMA+SBC resin (or the SMMA+impact modifier resin) remains transparent after exposure to the etch chemistry (i.e., etching process). It therefore overcomes one of the major negative features of PMMA in this type of application. For example, The SMMA+SBC resin retains good scratch resistance and has excellent UV resistance when compared to PC. Therefore, use of the SMMA+SBC resin in 2-shot selective plating applications does not require the use of a protective coating for scratch resistance or UV protection, thus reducing costs compared to a process that uses PC as a non-plateable resin. FIG. 3 is an example showing the SMMA resin plaques 30 after various stages of UV testing (see the SMMA resin 1, 2, and 3). It is evident that even after 5000 KJ of exposure to UV radiation, there is little if any yellowing or crazing of the SMMA resin.

Furthermore, as an example, it is shown that the SMMA+SBC resin does not react with the etch chemistry of the plating process. FIG. 4A shows the SMMA+SBC resin plaque 30 remains transparent and minimizes any haze or cloudiness. Conversely, as a prior art, FIG. 4B shows the PMMA plaque is not inert to the etch chemistry. While the PMMA is claimed as a non-plateable material in various patents, it can be demonstrated that such material will change on the surface after exposure to the highly oxidating conditions of the etch chemistry. This makes PMAA a poor choice for a non-plateable resin when transparency is desired. Furthermore, there are conditions in the process in combination with various PMMA resin grades where the molded part will develop metallization in the process thus making those particular resins poor choices as non-plateable resins.

Further, FIG. 4B shows that a PMMA resin, trade name Acrylite H15-003, is roughened by the etch chemistry (see PMMA plaque). The yellow color on the PMMA plaque is due to residual hex-Cr that is absorbed on the surface. Conversely, in FIG. 4A, the SMMA+SBC resin plaque 30 is unchanged. This comparison demonstrates that not all PMMA resins are inert to the plating process and are therefore not necessarily non-plateable.

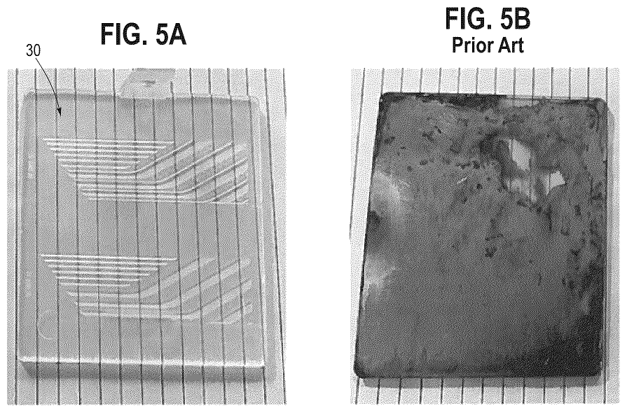

In addition, the roughening of the surface of the PMMA plaque leads to absorption of catalyst during the plating process which in turn leads to metallization of the plaque, thus demonstrating that not all PMMA is non-plateable. For example, FIGS. 5A and 5B compare the SMMA+SBC resin plaque 30 (see FIG. 5A) and PMMA plaque (see FIG. 5B) after completing the plating process through electroless Cu.

Referring back to FIGS. 1 through 2A, the first member 12, 102 and the second member 14, 104 are integrally formed and thus create a single, unitary body, for example, formed by a two-shot injection molding or over-molding process, so that they are bonded or fused together. Further, due to the combination of the plateable resin and non-plateable resin in FIGS. 1 and 1A, the polymeric component 10 has at least a portion of the metallized surface regions and at least a portion of the non-metallized surface. The polymeric component 10 is made as either a single workpiece or two-pieces overmolded on to each other and then processed as a whole through the plating line. Further, the polymeric component 10 and 100 reduces the number of pieces that are required to produce the article such that the manufacturing cost is reduced by the reduced process steps, fewer tools and fixtures, and reducing processing time to make the polymeric component 10 and 100 of the present disclosure.

It will be appreciated that illustrated plaque and schematic illustrations provided herein are exemplary, and that the molded component may take on various shapes, sizes, and constructions, while providing the above described advantageous aspects and combinations thereof. For example, the part can contain a curvature and may include a variety of curved or shaped interfaces between the various plated and non-plated regions.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A polymeric component for a vehicle, the polymeric component comprising:
a first member formed of a first polymer resin, the first member including a first exposed surface; and
a second member formed of a non-plateable resin and molded with the first member, the second member including a second exposed surface, wherein the non-plateable resin of the second member is an acrylate resin comprising SMMA (Styrene Methyl Methacrylate copolymer) resin;
wherein the second exposed surface has a non-metallic finish.

2. The polymeric component of claim 1, wherein the first polymer resin is plateable including at least one of ABS, PC/ABS, or ABS/PC, wherein the first exposed surface is plated with a metallic finish.

3. The polymeric component of claim 1, wherein the first polymer resin is non-plateable including at least one of PC, ASA, or ASA/PC, wherein the first exposed surface has a non-metallic finish.

4. The polymeric component of claim 1, wherein the SMMA resin includes an impact modifier material.

5. The polymeric component of claim 2, wherein, after a plating process, the polymeric component includes at least a 3-tone appearance including an exposed metallized region, a covered and visibly colored region, and a non-metallized region.

6. The polymeric component of claim 5, wherein the colored region of the polymeric component includes a first portion of the first member and a second portion of the second member molded with the first portion of the first member such that a color of the first member is visible through the second portion of the second member, wherein the first and second members are molded together via overmolding or two-shot molding, and wherein the first member is molded onto the second member or the second member is molded onto the first member.

7. The polymeric component of claim 5, wherein the colored region of the polymeric component further includes a texture and defines a 4-tone appearance.

8. The polymeric component of claim 5, wherein the colored region and the non-metallized region of the polymeric component define the second exposed surface formed with the non-metallic finish.

9. The polymeric component of claim 5, wherein the non-metallized region of the polymeric component further includes a backlight such that a light of the backlight passes through the non-metallized region.

10. The polymeric component of claim 3, wherein the polymeric component includes a 3-tone appearance including an exposed non-metallized region, a covered and visibly colored region, and a non-metallic SMMA region including an impact modifier.

11. The polymeric component of claim 10, wherein the non-metallized region of the polymeric component is tinted and/or diffused.

12. A method for forming a polymeric component for a vehicle, the method comprising the steps of:
providing a first member formed of a first polymer resin; and
combining a second member formed of a non-plateable resin with the first member, wherein the non-plateable resin of the second member is an acrylate resin comprising a SMMA (Styrene Methyl Methacrylate copolymer) resin,
wherein the polymeric component includes a first exposed surface formed on the first member and a second exposed surface formed on the second member, and the second exposed surface has a non-metallic finish.

13. The method of claim 12, wherein the step of combining the second member with the first member includes the step of molding the second member onto the first member by a two-shot injection molding process or an overmolding process, wherein the first polymer resin of the first member is plateable or non-plateable.

14. The method of claim 12, wherein the step of combining the second member with the first member includes the step of molding the first member onto the second member by a two-shot injection molding process or an overmolding process, wherein the first polymer resin of the first member is plateable or non-plateable.

15. The method of claim 12, wherein the SMMA resin includes an impact modifier material.

16. The method of claim 12, wherein the first polymer resin is plateable including at least one of ABS, PC/ABS, or ABS/PC, wherein the first exposed surface is plated with a metallic finish.

17. The method of claim 16, wherein, after a plating process, the polymeric component includes at least a 3-tone appearance including an exposed metallized region, a covered and visibly colored region, and a non-metallized region.

18. The method of claim 17, wherein the colored region of the polymeric component further includes a texture defining a 4-tone appearance.

19. The method of claim 12, wherein the first polymer resin is non-plateable including at least one of PC, ASA, or ASA/PC, wherein the first exposed surface has a non-metallic finish.

20. The method of claim 19, wherein the polymeric component includes at least a 3-tone appearance including an exposed non-metallized region, a covered and visibly colored region, and a non-metallic SMMA region including an impact modifier.
